(19) United States
(12) Patent Application Publication
(10) Pub. No.: US 2007/0225060 A1
(43) Pub. Date: Sep. 27, 2007

(54) VIDEO SLOT MACHINE ALLOWING EXTRA BETS

(75) Inventor: Toshiyuki YOSHIMURA, Zama city (JP)

Correspondence Address: GLOBAL IP COUNSELORS, LLP, 1233 20TH STREET, NW, SUITE 700, WASHINGTON, DC, 20036-2680, US

(73) Assignee: KONAMI GAMING INCORPORATED, Las Vegas, NV (US)

(21) Appl. No.: 11/689,491

(22) Filed: Mar. 21, 2007

(30) Foreign Application Priority Data
Mar. 24, 2006 (JP) 2006-083416

(51) Int. Cl. A63F 13/00

(52) U.S. Cl. 463/20

(57) ABSTRACT

In a video slot machine according to the present invention, a display unit displays video reels. Each video reel includes first or second series of symbols, which are equivalent except for the types of wildcard symbols. A console unit allows a player to add an extra bet to normal bets. A display control unit causes the display unit to use the first or second series of symbols when the console unit has accepted normal bets with or without an extra bet, respectively. Thus, the different types of wildcard symbols appear on the video reels depending on the types of bets. If a winning combination is formed in the arrangement of the stopped symbols, an award processing unit changes the amount of an award depending on which type of wildcard symbol the winning combination includes.

### BACKGROUND OF THE INVENTION

1. Field of the Invention

The present invention relates to a video slot machine that is installed in a casino or the like.

2. Background Information

A general video slot machine installed in a casino or the like displays an image that represents a plurality of virtual reels (video reels) on a screen. Each of the video reels comprises various types of symbols that are arranged in a predetermined order. One or more symbols of each video reel are displayed and constitute an arrangement on the screen. The arrangement of displayed symbols includes one or more paylines. Here, a payline is a series of symbols, and in particular, includes one symbol on each video reel. A player enters an amount of credits as a bet into the video slot machine by using its console unit. The bet is, in general, allowed to be placed on each payline. After the player has placed one or more bets, the video slot machine generates a start signal. In response to the start signal, first, a lottery unit of the video slot machine performs a lottery process to determine a stopped symbol on each video reel to be displayed on the screen. Next, the video slot machine checks whether or not a winning combination is formed on a payline in the arrangement of the stopped symbols. In parallel with that, the video slot machine starts continuously changing the symbols of the video reels on the screen, i.e., starts “a spin” of the video reels. After a predetermined time has elapsed, for example, the video slot machine displays an arrangement of the stopped symbols on the screen, i.e., stops the “spin” of the video reels, and provides the player with an award (e.g., an amount of credits) depending on the bet and the winning combination found in the arrangement of the stopped symbols.

In general, the variety of bets per spin is limited by the number of paylines. Accordingly, the variety of credits to be provided to a player as an award is also limited by the number of paylines. Alternatively, there is a prior art slot machine that allow a player to add an extra amount of credits to the normal amount of a bet in order to increase the amount of credits to be provided as an award (cf. Japan Registered Utility Model No. 306192). The amount of credits to be provided in each award is uniformly increased with the extra amount of credits, regardless of the number of paylines.

The wider variety of awards, especially the larger amount of credits to be provided, may attract a larger number of players. However, the limitation of the variety of bets imposed by the number of paylines prevents the variety of awards from increasing. In the above-mentioned prior art slot machine, the uniform increase in the amount of credits to be provided in each award prevents the variety of awards from further increasing. In addition, it is desirable for a slot machine to be capable of informing a player of the increase in the amount of credits to be provided as an award more clearly but more simply than the prior art slot machine, which simply changes the appearance of a pay table in response to the increase in the amount of credits.

In view of the above, it will be apparent to those skilled in the art from this disclosure that there exists a need for an improved video slot machine that more freely changes the variety of awards depending on the bets placed, and informs players of the changes more clearly but simply, and thereby enhances players' willingness to play games. This invention addresses this need in the art as well as other needs, which will become apparent to those skilled in the art from this disclosure.

### SUMMARY OF THE INVENTION

A video slot machine according to the present invention comprises a display unit, a console unit, a bet processing unit, a start signal generator unit, a lottery unit, a display control unit, a winning judgment unit, and an award processing unit.

The display unit is configured to display a plurality of video reels. Each of the video reels selectively comprises a first and second series of symbols. The second series of symbols is equivalent to the first series of symbols except for the replacement of one or more symbols with specific symbols.

The console unit is configured to allow a player to enter one of normal bet data and extra bet data therein. Preferably, the normal bet data and the extra bet data each represent the amount of a normal bet that a player has placed on each payline. Here, the variety of normal bets is limited by the number of paylines as usual. On the other hand, the extra bet data further represents that the player has instructed the video slot machine to use the normal bet with an extra bet, i.e., an additional amount of credits.

The bet processing unit is configured to receive an amount of credits equal to the amount of a bet represented by the normal bet data when the console unit has accepted the normal bet data, and receive an amount of credits equal to the amount of a bet represented by the extra bet data plus a predetermined amount, i.e., an extra bet, when the console unit has accepted the extra bet data.

The start signal generator unit is configured to generate a start signal after the bet processing unit has received an amount of credits. The lottery unit is configured to determine a stopped symbol on each video reel to be displayed on the display unit in response to the start signal. The display control unit is configured to cause the display unit to start continuously changing symbols on the video reels in response to the start signal, and after that, display an arrangement of the stopped symbols that the lottery unit has determined. The symbols are changed in order in the first and second series when the console unit has accepted the normal and extra bet data, respectively. Thus, the specific symbols appear on the video reels only when the player has instructed the video slot machine to use a normal bet with an extra bet.

The winning judgment unit is configured to check whether or not one or more winning combinations are included in the arrangement of the stopped symbols that the lottery unit has determined. The award processing unit is configured to provide the player with an award in accordance with the normal bet data, the extra bet data, and a winning combination, when the winning judgment unit has found the winning combination in the arrangement of the stopped symbols. Preferably, the award processing unit changes awards depending on whether or not a winning combination found by the winning judgment unit includes any of the specific symbols. More preferably, the award processing unit pays the player a larger amount of credits for a winning combination with any of the specific symbols, than for an equivalent winning combination including none of the specific symbols. Alternatively, a special award (e.g., the right to play a special game) may be provided to a player only if an extra bet has been placed on a payline matching with a winning combination.

As described above, the video slot machine of the present invention allows a player to place an extra bet on each selected payline in addition to a normal bet. If a winning combination is formed on a selected payline, but includes none of the specific symbol, the player will win a normal award regardless of adding the extra bet to the normal bet. In other words, the player will lose the extra bet even if the player wins the game. If a winning combination is formed on a selected payline, and includes a specific symbol, the player will win a special award (a larger amount of credits or the right to play a special game). In this way, the video slot machine of the present invention increases the risk of adding an extra bet to a normal bet, and thereby, can achieve an even wider variety of awards. This may attract a larger number of players to play games on the video slot machine. In addition, the appearance of the specific symbols can clearly and simply inform players of the ability to add an extra bet to a normal bet. Furthermore, the visual effect of the specific symbols passing through the paylines may enhance players' excitement more effectively.

Preferably, the specific symbols include a wildcard symbol. A wildcard symbol is one of the most attractive symbols for players. Accordingly, the above visual effect may be more effective. More preferably, one of the video reels selectively comprises a first series of symbols including a wildcard symbol, and a second series of symbols that is equivalent to the first series of symbols except for the replacement of the wildcard symbol with another wildcard symbol. In other words, the replaced symbols between the first and second series have a similar wildcard function. This may reduce the burdens on the winning judgment unit and the award processing unit, independent of whether or not an extra bet has been placed.

These and other objects, features, aspects and advantages of the present invention will become apparent to those skilled in the art from the following detailed description, which, taken in conjunction with the annexed drawings, discloses a preferred embodiment of the present invention.

### BRIEF DESCRIPTION OF THE DRAWINGS

Referring now to the attached drawings which form a portion of this original disclosure:

FIG. 1 is a flow chart of a round of a game on a video slot machine according to an embodiment of the present invention;

FIG. 2 is a perspective view of the appearance of a video slot machine according to an embodiment of the present invention;

FIG. 3 is a block diagram of the hardware configuration of a main controller unit included in the video slot machine shown in FIG. 2;

FIG. 4 is a block diagram of the hardware configuration of a sub-controller unit included in the vide slot machine shown in FIG. 2; and

FIG. 5 shows two examples (a) and (b) of the arrangement of stopped symbols on a game screen when the console unit has accepted only normal bets, and when the console unit has accepted an extra bet, respectively.

### DETAILED DESCRIPTION OF THE PREFERRED EMBODIMENT

Selected embodiments of the present invention will now be explained with reference to the drawings. It will be apparent to those skilled in the art from this disclosure that the following descriptions of the embodiments of the present invention are provided for illustration only and not for the purpose of limiting the invention as defined by the appended claims and their equivalents.

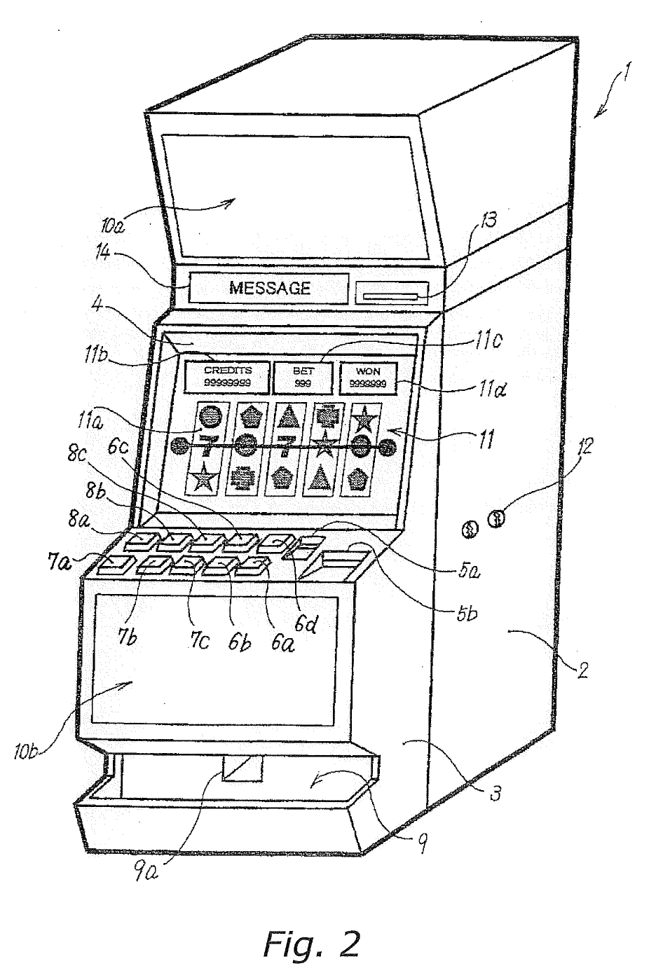

A preferred embodiment of the present invention is a video slot machine preferably installed in a casino. At first, the basic configuration of the slot machine will be described below. As shown in FIG. 2, the slot machine 1 comprises a box-shaped cabinet 2, and a front panel 3 that is coupled to the front of the cabinet 2 so that it can be opened and closed. On the front panel 3 are provided, for example, a display window 4, a coin slot 5a, a bill slot 5b, a spin button 6a, a cash out button 6b, extra bet buttons 6c, 6d, normal bet buttons 7a, 7b, 7c, payline selection buttons 8a, 8b, 8c, a coin tray 9, and various types of lamps 10a and 10b. A monitor 11 is visible through the display window 4. Coins are discharged from a coin chute 9a, and then stored in the coin tray 9. The buttons 6a, 6b, 6c, 6d, 7a, 7b, 7c, 8a, 8b, and 8c are, preferably, mechanical lamp buttons including light emitting devices which emit light when pushed. Alternatively, the buttons may be virtual button images displayed on a touch panel mounted on the monitor 11.

The monitor 11 is placed inside the slot machine 1. The monitor 11 displays a column of various symbols arranged in a predetermined order, i.e. a video reel, on each of five symbol display areas 11a. The monitor 11 is preferably included in a liquid crystal display, or alternatively, may be included in a cathode-ray-tube display or a plasma display. The monitor 11 also displays a credit display area 11b, a bet display area 11c, and an award display area 11d above the symbol display areas 11a. The total amount of money that a player has inserted into the coin slot 5a and the bill slot 5b, or the amount of credits available to the player, appears in the credit display area 11b. The amount of bets that the player has placed by using the buttons 6c, 6d, 7a, 7b, 7c, 8a, 8b, and 8c appears in the bet display unit 11c. The amount of credits that the player has won as a result of a game appears in the award display area 11d.

A coin counter, a coin acceptor, a coin payout device, and a speaker are installed inside the slot machine 1 (not shown in FIG. 2.) The coin counter counts the amount of coins and bills inserted into the coin slot 5a and the bill slot 5b, respectively. The coin acceptor validates the coins and bills. The coin payout device includes a hopper, and can hold a large number of coins.

A reset switch 12 is provided on one side of the slot machine 1. The reset switch 12 preferably includes a keyhole, and is activated by the insertion of a specific key into the keyhole. The specific keys are preferably possessed by casino attendants. Accordingly, players cannot operate the reset switch 12.

A card slot 13 and a sub-display unit 14 are mounted on an upper portion of the slot machine 1. A house card can be inserted into the card slot 13. Here, the house card is a removable recording medium usable within the casino, and provided to each player who has, for example, registered at a reception desk of the casino. The house card stores data for identification of an individual player, i.e., a player ID. On the other hand, a management server installed in the casino stores personal information on each registered player and is linked to a player ID. The management server also stores an amount of credits for each player, which is equivalent to the amount of money that the player has entrusted to the casino in advance, and is linked to the player ID therefor. The house card is used by the managing server in order to keep track of the number of points that represents the amount of credits that the player has spent on games. The player can be provided with bonuses such as free accommodation coupons, depending on the total number of the points. The sub-display unit 14 displays the number of the points provided to the player. The house card is further used in allowing the money that has been entrusted to the casino in advance to be used as credits in playing games on the slot machine 1 (details will be described below).

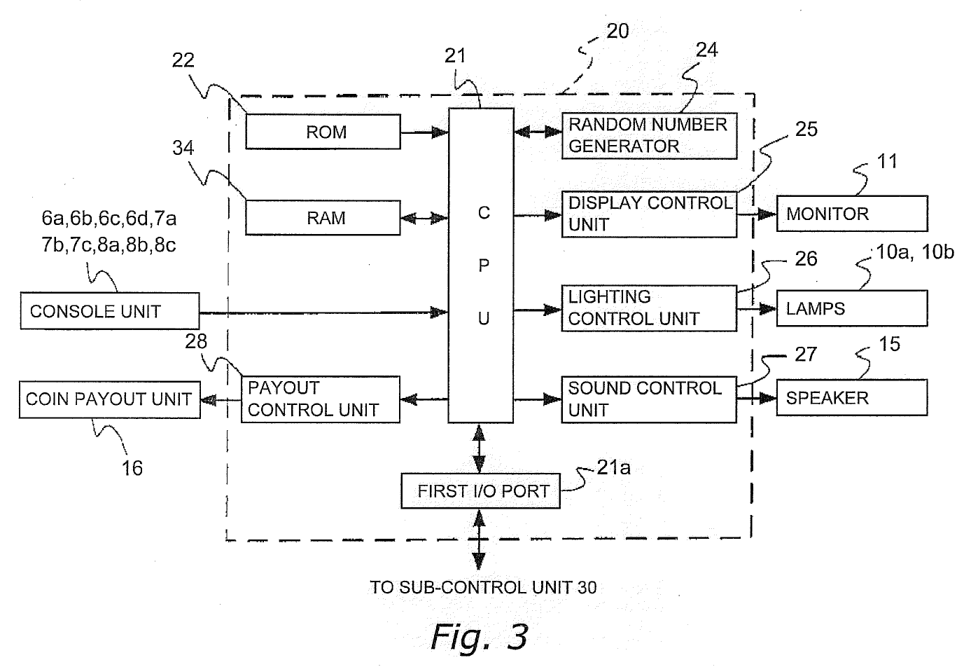

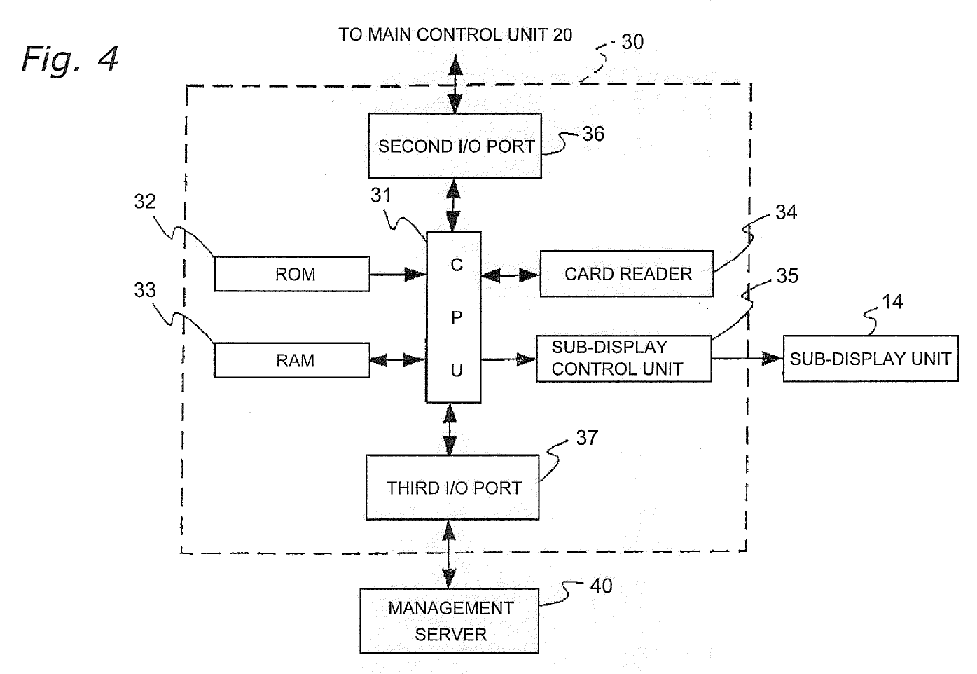

The slot machine 1 comprises a main controller unit 20 and a sub-controller unit 30 (cf. FIGS. 3 and 4).

As shown in FIG. 3, the main controller unit 20 includes a first CPU 21, a first I/O port 21a, a first ROM 22, a first RAM 23, a random number generator 24, a display control unit 25, a lighting control unit 26, a sound control unit 27, and a payout control unit 28. The first I/O port 21a is used in data communication between the main controller unit 20 and the sub-controller unit 30. The first ROM 22 stores various programs and databases for use by the first CPU 21. The first RAM 23 temporarily stores parameters computed by the first CPU 21. The random number generator 24 generates and provides random numbers to the first CPU 21 at regular intervals. The display control unit 25 controls display on the monitor 11 under the control of the first CPU 21. The lighting control unit 26 switches the lamps 10a and 10b on and off under the control of the first CPU 21. The sound control unit 27 controls the speaker 15 to reproduce voice announcements, sound effects, and the like, under the control of the first CPU 21. The payout control unit 28 controls the coin payout device 16, thereby supplying a proper amount of coins through the coin chute 9a to the coin tray 9 under the control of the first CPU 21.

The spin button 6a, the cash out button 6b, the various bet buttons 6c, 6d, 7a, 7b, 7c, and the payline selection buttons 8a, 8b, and 8c constitutes a console unit, which is connected to the first CPU 21. Moreover, the coin counter and the coin acceptor is also connected to the first CPU 21 (not shown in the figures).

As shown in FIG. 4, the sub-controller unit 30 includes a second CPU 31, a second ROM 32, a second RAM 33, a card reader 34, a sub-display control unit 35, a second I/O port 36, and a third I/O port 37. The second ROM 32 stores various programs and data bases for use by the second CPU 31. The second RAM 33 temporally stores parameters computed by the second CPU 31. The card reader 34 reads a player ID from the house card inserted into the card slot 13, and provides the player ID to the second CPU 31. The sub-display control unit 35 controls the sub-display unit 14 under the control of the second CPU 31. The second I/O port 36 is used in data communication between the main controller unit 20 and the sub-controller unit 30. The third I/O port 37 is used in data communication between the sub-control circuit board 30 and the management server 40 of the casino. Here, the management server 40 collectively controls a plurality of gaming machines in the casino, including the slot machine 1.

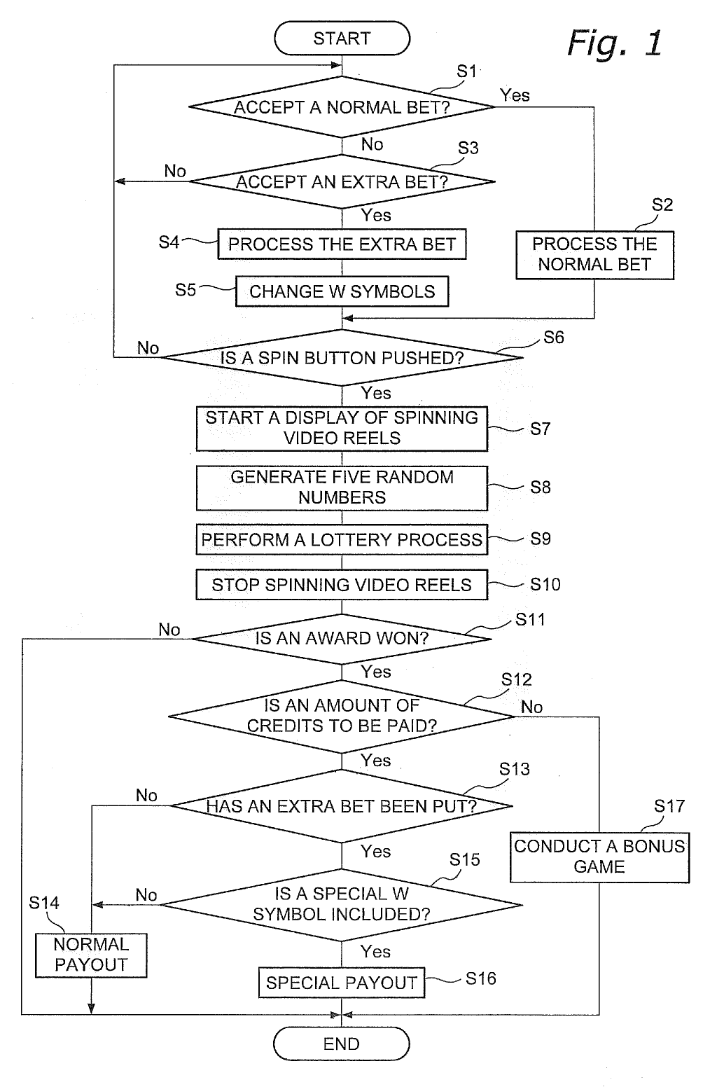

Next, the operation of each unit of the slot machine 1 will be explained in the order of the flow of a slot game on the slot machine 1 (cf. FIG. 1).

A player inserts coins or bills into the coin slot 5a or the bill slot 5b, respectively. Then, the coin acceptor validates the coins and bills, and the coin counter counts the authorized coins and bills. The first CPU 21 of the main controller unit 20 reads the count of the coin counter, and updates credit data stored in the first RAM 23 to increase credits by the number corresponding to the count.

The player can use an amount of credits stored in the management server 40 in the following steps. First, the player inserts a house card in which his/her own player ID is stored into the card slot 13. Then, the card reader 34 of the sub-control unit 30 reads the recorded player ID from the inserted house card, and sends the read player ID to the second CPU 31 of the sub-control unit 30. The second CPU 31 receives the player ID from the card reader 34, and determines whether the player ID is valid or not. Note that the management server 40 may perform the determination instead of the controller unit of the slot machine 1. In this case, the second CPU 31 sends the received player ID to the management server 40, and then receives the results of the determination by the management server 40 as a response to the player ID.

When the player ID is determined to be invalid, the second CPU 31 sends a signal indicating the invalidity to the first CPU 21 of the main control unit 20. The first CPU 21 receives the signal, and then commands the display control unit 25 to display an error message on the monitor 11. On the other hand, the second CPU 31 commands the card reader 34 to discharge the house card from the card slot 13 by using a card discharge signal.

When the player ID is determined to be valid, the second CPU 31 sends a request for credit data linked to the player ID received from the card reader 34 to the management server 40 through the third I/O port 37. In response to the request, the management server 40 retrieves the credit data linked to the player ID from a database, and then sends the credit data to the slot machine 1. The third I/O port 37 of the sub-control unit 30 receives the credit data, and then the second CPU 31 transfers the credit data from the third I/O port 37 to the first CPU 21 of the main control unit 20. The first CPU 21 uses the received credit data to update the credit data stored in the first RAM 23. Thus, the player can use an amount of credits stored in the management server 40 in playing games on the slot machine 1. In this case, players do not have to carry cash within the casino. This facilitates playing games in the casino.

The player is allowed to place a desired normal bet on a desired payline by using the console unit, in particular, the normal bet buttons 7a, 7b, 7c, and the payline selection buttons 8a, 8b, 8c (Step S1). Here, the variety of normal bets is limited by the number of paylines. The slot machine 1 comprises three paylines, and allows the player to selectively place 1-3 units of credits on each payline as a normal bet, for example. More specifically, the player selectively pushes the payline selection buttons 8a, 8b, 8c corresponding to the desired paylines. Next, the player selectively pushes the normal bet buttons 7a, 7b, and 7c corresponding to the desired normal bet, 1, 2, or 3 units of credits. The console unit accepts the operation of placing normal bets, and sends data indicating the contents of the operations (hereinafter, normal bet data) to the first CPU 21 of the main controller unit 20. Then, the first CPU 21 changes its status to enable an operation signal from the spin button 6a, and thereby the player is allowed to spin the video reels by using the spin button 6a. In parallel to that, the first CPU 21 functions as a bet processing unit, i.e., updates credit data stored in the first RAM 23 to decrease the amount of the credits by the total amount of the normal bets indicated by the normal bet data (Step S2). For example, the player places the same amount (e.g., 2 units) of credits on each of the selected paylines (e.g., 3 paylines), and then the total amount of the normal bets is equal to the product of the number of the selected paylines and the amount of the credits per payline (e.g., 6 units of credits).

The player is also allowed to add a desired extra bet to normal bets at each spin by using the console unit, in particular, the extra bet buttons 6c and 6d, after placing normal bets (Step S3). Here, the variety of an extra bet is not limited by the number of paylines, and is preferably predetermined to be a fixed amount of credits per spin. For example, the slot machine 1 allows the player to selectively push the extra bet buttons 6c and 6d, and respectively add 2 and 5 units of credits to the total amounts of credits previously placed thereon as normal bets. For example, when the player pushes the first extra bet button 6c or the second extra bet button 6d after placing 2 units of credits on each of the 3 paylines, 8 or 11 units of credits are placed on the slot machine 1 in total.

The console unit accepts the placement of the normal bets and the extra bet, and sends data indicating the contents of these operations (hereinafter, extra bet data) to the first CPU 21 of the main controller unit 20. Then, the first CPU 21 changes its status to enable an operation signal from the spin button 6a, and thereby the player is allowed to operate a spin of the video reels by using the spin button 6a. In parallel to that, the first CPU 21 functions as a bet processing unit, i.e., updates credit data stored in the first RAM 23 to decrease the amount of the credits by the total amount of the normal bets plus the extra bet indicated by the extra bet data (Step S4).

Preferably, the slot machine 1 allows the player to push the extra bet button 6c or 6d until the spin button 6a is pushed after the console unit has sent the normal bet data to the first CPU 21. Accordingly, the first CPU 21 updates credit data stored in the first RAM 23 to decrease the amount of the credits by the total amount of the bets after the player pushes the spin button 6a.

An extra bet added to a normal bet causes the slot machine 1 to change in neither the number of paylines nor the probability of a winning combination formed on a payline, but does change some symbols to specific symbols on the video reels, and the types of awards when a winning combination includes one of the specific symbols. The slot machine 1 in particular replaces a wildcard symbol (hereinafter, an original W symbol) with another wildcard symbol (hereinafter, a special W symbol) (Step S5).

The original W symbol is replaced with the special W symbol as described below. The display control unit 25 stores first and second series of ten symbols for use on each video reel. The first series of ten symbols is arranged in a predetermined order. The second series of ten symbols is equivalent to the first series of ten symbols except for the replacement of the original W symbol with the special W symbol. In FIG. 2, for example, the display control unit 25 displays three symbols arranged in the vertical direction that constitute a video reel on each of the five symbol display areas 11a. The three symbols on each video reel are consecutive symbols belonging to the first or second series of ten symbols when the player places a normal or extra bet on the slot machine 1.

More specifically, the first CPU 21 receives normal bet data, and then commands the display control unit 25 to use the first series of symbols. Accordingly, a game screen of a slot game includes a portion of the first series of symbols on each of the five symbol display areas 11a. On the other hand, the first CPU 21 receives extra bet data, and then commands the display control unit 25 to change from the first series of symbols to the second series of symbols. Accordingly, a game screen of a slot game includes a portion of the second series of symbols on each of the five symbol display areas 11a.

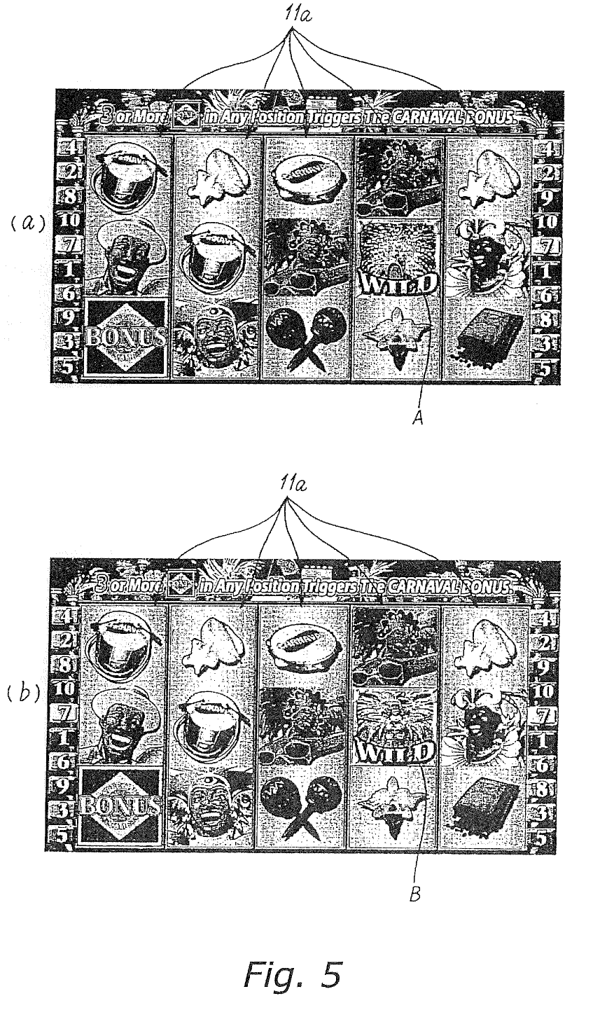

In particular, if portions of the first series of symbols including an original W symbol A constitute an arrangement displayed on the five symbol display areas 11a (cf. FIG. 5A), corresponding portions of the second series of symbols constitute an equivalent arrangement except for the replacement of the original W symbol A with a special W symbol B (cf. FIG. 5B).

The first CPU 21 of the main controller unit 20 updates credit data stored in the first RAM 23 on the basis of normal or extra bet data, when the player pushes the spin button 6a (Step S6). Then, the first CPU 21 functions as a start signal generator unit, i.e., generates and sends a start signal to the display control unit 25. In response to the start signal, the display control unit 25 starts the display of spinning video reels, i.e., the continuous change of symbols displayed on the five symbol display areas 11a of the monitor 11 (Step S7).

The first CPU 21 and the random number generator 24 functions as a lottery unit as follows. The first CPU 21 sends the start signal to the random number generator 24. In response to the start signal, the random number generator 24 generates five random numbers, and provides them in turn to the first CPU 21 (Step S8). Each of the five random numbers is assigned to a video reel displayed on one of the five symbol display areas 11a. The first CPU 21 accesses the first ROM 22, and compares the five random numbers with items of the respective tables (hereinafter, stop position tables). Each of the stop position tables is assigned to a video reel displayed on one of the five symbol display areas 11a, and represents a predetermined link between random numbers and symbols included in each video reel. The first CPU 21 then determines the stop positions of the video reels that indicate symbols linked to the random numbers in the stop position tables. The symbols will be displayed on the five symbol display areas 11a as stopped video reels after the display of spinning video reels.

The first CPU 21 and the random number generator 24 also functions as an award processing unit, i.e., they determine whether or not to provide an award to the player under a lottery process as follows. The first CPU 21 accesses the first ROM 22, and compares the combination of the five random numbers with the items of a table (hereinafter, a winning combination table) that represents a predetermined link between combinations of five random numbers and awards (Step S9). The awards are broadly divided into predetermined amounts of credits and rights to play a bonus game, i.e., a special game such as an event, a free game, a feature game, or the like. If there is an award linked to the combination of the five random numbers in the winning combination table, the first CPU 21 then decides to provide the award to the player. Note that the first ROM 22 stores two types of winning combination tables: the first type thereof is used when only the normal bets has been placed, and the second type thereof is used when the extra bets has been added to the normal bets. Preferably, a first-type winning combination table is assigned to each payline.

The awards are linked to the combinations of the five random numbers. Each of the random numbers is linked to a symbol in one of the stop position tables. Accordingly, the awards are linked to specific arrangements (i.e., winning combinations) of symbols included in the stopped video reels displayed on the five symbol display areas 11a. Preferably, winning combinations are assigned to arrangements where symbols of the same type (and a wildcard symbol) are stopped in three or more consecutive symbol display areas. The types of awards (e.g., the amounts of credits or bonus games) depend on which types of symbols are repeatedly included in the corresponding winning combinations.

After the lottery process, the first CPU 21 controls the display control unit 25 to change from the spinning video reels to the stopped video reels on the five symbol display areas 11a of the monitor 11 (Step S10). Thus, the symbols linked to the random numbers in the stop position tables are arranged on the five symbol display areas 11a.

If an amount of credits is to be provided to the player under the lottery process (“YES” in Steps S11 and S12), the first CPU 21 will check whether only normal bets have been placed during the game round or an extra bet has been added (Step S13). When only the normal bets have been placed during the game round, the first CPU 21 performs a normal payout procedure (Step S14). More specifically, the first CPU 21 functions as a payout processing unit, i.e., updates the credit data stored in the first RAM 23 to increase the player's credits by the product of the normal bets and normal odds corresponding to the winning combinations. Note that normal odds are common between winning combinations with and without original W symbols.

When the first CPU 21 checks that an extra bet has been added in the game round at Step S13, the first CPU 21 will further check whether or not the winning combinations include a special W symbol (Step S15). When none of the winning combinations include a special W symbol, the first CPU 21 performs the normal payout procedure (Step S14). In particular, the payouts are the same as those in the normal payout procedure, and accordingly the extra bet is lost. When one of the winning combinations includes a special W symbol, the first CPU 21 performs a special payout procedure (Step S16). More specifically, the first CPU 21 functions as a payout processing unit, i.e., it updates the credit data stored in the first RAM 23 to increase the player's credits by the product of the normal bets and special odds corresponding to the winning combinations. Note that special odds depend on the amount of the extra bet. For example, when the amount of the extra bet is set to be 2 or 5 units of credits by the push of the first extra bet button 6c or the second extra bet button 6d, respectively, the special odds are 2 or 4 times as high as normal odds. Accordingly, the amount of credits paid for a winning combination with a special W symbol is 2 or 4 times as large as for the equivalent winning combination except for the replacement of the special W symbol with an original W symbol.

In parallel to the normal or special payout procedure, the first CPU 21 controls visual and sound effects. More specifically, the first CPU 21 provides the lighting control unit 26 and the sound control unit 27 with commands. The lighting control unit 26 then turns on and off the lamps 10a, 10b and the lamp buttons equipped with internal light emitting devices, such as the buttons 6a, 6b, 6c, 6d, 7a, 7b, 7c, 8a, 8b, and 8c, in the patterns represented by the commands. The sound control unit 27 changes sounds reproduced from the speaker 15 to the sound effects represented by the commands.

When the right to play a bonus game is to be provided to the player under the lottery process (“YES” in Step S11 and “NO” in Step S12), the first CPU 21 first controls visual and sound effects as described above. Next, the first CPU 21 changes from a normal game mode to a bonus game mode (Step S17). Then, the bonus game is allowed to proceed.

As described above, the console unit of the slot machine 1 (constituted by the buttons 6c, 6d, 7a, 7b, 7c, 8a, 8b, and 8c, and the first CPU 21) allows an extra bet to be placed, and the display control unit 25 replaces original W symbols A with special W symbols B (cf. FIGS. 5A and 5B) when the console unit accepts an extra bet. In order to place an extra bet, a player has to pay an additional amount of credits, which will be lost when no winning combinations with the special W symbol are formed on paylines on which the bets have been placed. However, if a winning combination with the special W symbol is formed on one of the paylines, a larger amount of credits will be provided to the player than when only normal bets have been placed. Thus, the slot machine 1 increases the risk of adding an extra bet to a normal bet, and thereby, can achieve an even wider variety of awards. This may attract a larger number of players to play games on the slot machine 1. In addition, the appearance of the special W symbols can clearly and simply inform players of adding an extra bet to a normal bet. Furthermore, the visual effect of the special W symbols passing through the paylines may enhance players' excitement more effectively.

The additional amount of credits serving as an extra bet is fixed to be a constant amount of credits (e.g., 2 or 5 units of credits) per spin. Instead of that, the total amount of normal bets and an extra bet may be fixed to be a constant amount, which is, for example, larger than the product of the maximum amount of credits and the maximum number of paylines (e.g., 3 units of credits times 3 paylines=9 units of credits) by a predetermined units of credits. In that case, the player may be allowed to push the extra bet buttons 6c and 6d without placing any normal bet, and thereby the maximum unit of credits may be automatically placed on every payline as a normal bet. Furthermore, the additional amount of credits serving as an extra bet may be a percentage of the total amount of normal bets.

The slot machine 1 preferably increases a payout for a winning combination with a special W symbol. Alternatively, the right to play a bonus game may be provided to a player.

The slot machine 1 preferably replaces original W symbols with special W symbols when the console unit accepts an extra bet. Alternatively, one or both of the original and special W symbols may be changed to other symbols.

### General Interpretation of Terms

In understanding the scope of the present invention, the term “configured” as used herein to describe a component, section or portion of a device includes hardware and/or software that is constructed and/or programmed to carry out the desired function. In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Also, the terms “part,” “section,” “portion,” “member” or “element” when used in the singular can have the dual meaning of a single portion or a plurality of portions. Finally, terms of degree such as “substantially”, “about” and “approximately” as used herein mean a reasonable amount of deviation of the modified term such that the end result is not significantly changed. For example, these terms can be construed as including a deviation of at least ±5% of the modified term if this deviation would not negate the meaning of the word it modifies.

While only selected embodiments have been chosen to illustrate the present invention, it will be apparent to those skilled in the art from this disclosure that various changes and modifications can be made herein without departing from the scope of the invention as defined in the appended claims. Furthermore, the foregoing descriptions of the embodiments according to the present invention are provided for illustration only, and not for the purpose of limiting the invention as defined by the appended claims and their equivalents.

What is claimed is:

1. A video slot machine comprising:
a display unit configured to display a plurality of video reels, each of the video reels selectively comprising a first series of symbols arranged in a predetermined order, and a second series of symbols that is equivalent to the first series of symbols except for the replacement of one or more symbols with specific symbols;
a console unit configured to allow a player to enter one of normal bet data and extra bet data therein;
a bet processing unit configured to receive an amount of credits equal to an amount of a bet represented by the normal bet data when the console unit has accepted the normal bet data, and receive an amount of credits equal to an amount of a bet represented by the extra bet data plus a predetermined amount when the console unit has accepted the extra bet data;
a start signal generator unit configured to generate a start signal after the bet processing unit has received an amount of credits;
a lottery unit configured to determine a stopped symbol on each video reel to be displayed on the display unit in response to the start signal;
a display control unit configured to cause the display unit to start continuously changing the symbols of the video reels in response to the start signal, and after that, display an arrangement of the stopped symbols that the lottery unit has determined, where the symbols are changed in the order of the first and second series when the console unit has accepted the normal and extra bet data, respectively;
a winning judgment unit configured to check whether or not one or more winning combinations are included in the arrangement of the stopped symbols that the lottery unit has determined; and
an award processing unit configured to provide the player with an award in accordance with the normal bet data, the extra bet data, and a winning combination, when the winning judgment unit has found the winning combination in the arrangement of the stopped symbols.

2. The video slot machine according to claim 1, wherein the award processing unit changes awards depending on whether or not a winning combination found by the winning judgment unit includes any of the specific symbols.

3. The video slot machine according to claim 2, wherein the award processing unit pays the player a larger amount of credits for a winning combination with any of the specific symbols, than for an equivalent winning combination including none of the specific symbols.

4. The video slot machine according to claim 1, wherein the specific symbols include a wildcard symbol.

5. The video slot machine according to claim 4, wherein one of the video reels selectively comprises a first series of symbols including a wildcard symbol, and a second series of symbols that is equivalent to the first series of symbols except for the replacement of the wildcard symbol with another wildcard symbol.
